(19) United States
(12) Patent Application Publication
(10) Pub. No.: US 2014/0232535 A1
(43) Pub. Date: Aug. 21, 2014

(54) METHOD AND APPARATUS FOR IMMERSIVE MULTI-SENSORY PERFORMANCES

(71) Applicant: Jonathan Issac Strietzel, Lakewood, CA (US)

(72) Inventor: Jonathan Issac Strietzel, Lakewood, CA (US)

(21) Appl. No.: 14/109,885

(22) Filed: Dec. 17, 2013

Related U.S. Application Data
(60) Provisional application No. 61/738,317, filed on Dec. 17, 2012.

(51) Int. Cl. G09B 21/00

(52) U.S. Cl. CPC G09B 21/003
USPC 340/407.2

(57) ABSTRACT

A system for providing a multisensory performance to a viewer comprising of a plurality of capture modules configured to capture one or more sensory inputs for the multisensory performance. At least one kernel module configured to organize the one or more sensory inputs to create the multisensory performance, and a plurality of output modules configured to present the multisensory performance to the viewer.

### BACKGROUND

1. Technical Field

The embodiments described herein can be related to physical performances, and more particularly to performances or lessons/teaching that create an immersive multi-sensory experience for its viewers.

2. Related Art

Conventionally, performances and teaching can be done in a variety of mediums, in small to large venues and in front of a crowd and in various types. For example, some traditional theater plays, extravagant performances such as a Cirque Du Soleil performances, a concert performance in front of a huge crowd, or at a small venue, a typical classroom, arena style class, or a typical panel/convention environment. While there can be many derivatives of the act of live, non-live, onstage and/or offstage performance, the typical performance that is absorbed by the public would be that of traditional class, lecture hall, speech, theatre, stand-up comedy and concerts where people can gather to enjoy the musical performance by an individual or group. Performances have also been known to be taped or created beforehand, altered and re-played for a theatrical or home audience, for example educational, music or concert filmed performances such as a feature film, speech, presentation, tutorial or concert content. There have been new and innovative performers that have taken the initiative to create “Alternative” and new performance ideas such as the band “The Gorillas” which performed as cartoon characters instead of a live band in front of an audience by using traditional theatre projection to simulate a live performance. There are those new thinkers that are currently performing at the time of this writing such as Skrillex, Avicii and other new-age DJ's that are incorporating image and video projecting into their on-stage performances giving them a “3D-Like” feel and interactive classrooms and speeches are a new trending medium for learning. For example Skrillex; is a modern DJ that uses traditional movie projectors that project effects onto his concert stage structures to create various imagery that surrounds him during his concerts, giving his stage an animated look and feel. The world of on-stage performance is rapidly changing as the tools for innovation become more accessible and easier to use. It will not be long until each of our live performance experiences, for example, but not limited to, entertainment, and, education are multi-sensory and completely immersive for example, but not limited to, creating a full-on “Augmented Reality”, “3D”, “Multi-sensory” or “Alternate Reality” during each of these experiences. The systems and methods described herein, outline a potential for the future of performance which includes, but is not limited to live an non-live performances of educational performances, speech/tutorial performance, on-stage performances, off-stage performances or a combination of the methods herein.

### SUMMARY

Systems and methods for the creation of a completely immersive on-stage experience is described herein.

Examples of these features, aspects, and embodiments are described below in the section entitled “Detailed Description” and should serve as an example of the systems and methods disclosed herein.

### BRIEF DESCRIPTION OF THE DRAWINGS

Features, aspects, and embodiments are described in conjunction with the attached drawings, in which:

FIG. 1 is a diagram illustrating an example of the overall elements/modules that describe the immersive multi-sensory system, but should not be limiting in any way, (FIGS. 2-10 “Modules”) with each module serving as an example of what an overall system could be comprised of.

### DETAILED DESCRIPTION

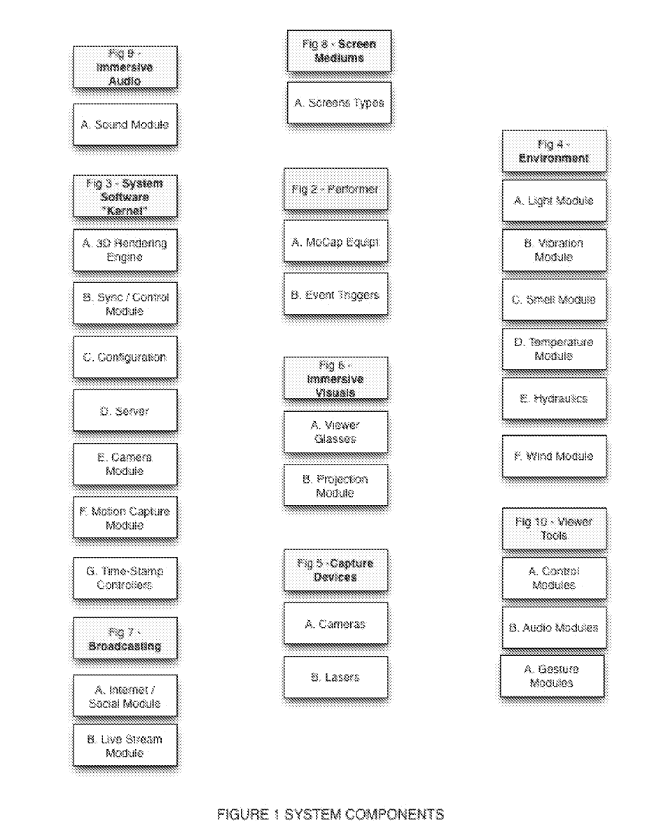

FIG. 1 is a diagram illustrating an example of some of the traditional components an embodiments of an immersive multi-sensory performance system. All of the components, working together to deliver a fully immersive, 3D, multi-sensory entertainment performance to the audience. It should be stated that FIG. 1 should not be limiting and it is an example of a number of system “Modules” that comprise the overall system. The example modules should in no way limit the overall system as there may be more modules, or less, dependent on the purposes and needs of the system that is being built.

FIG. 2 is a diagram that represents the actual performer(s). The performers can be outfitted with all of the necessary tracking equipment that will allow the System Software to track their performance in real-time and make the necessary adjustments to all of the other modules, for example, in real-time, if the performance is a live performance. The examples of the tracking equipment could be but is not limited to face feature tracking, eye tracking, mouth tracking, jaw tracking, audio tracking, vocal tracking, body heat, full body tracking, heart rate, speed of motion, location, head, torso, hand, finger, feet, arms and leg movements. If the performance is off-stage or offline, the software doesn't necessarily need to work in real-time and can take more time to make the best calculated decisions.

FIG. 3 represents and example but should not be limited to, the centralized software system or the “Kernel” which can essentially be the gatekeeper of the entire performance. The Kernel can take in and processes the data from each of its “Nodes” (All of the various high-level Figures in FIG. 1, for example, but not limited to FIGS. 2-10). The Kernel can make intelligent decisions that can push the proper data to each of its Nodes which can trigger Node events such as a special effect being rendered from the 3A. the “3D Rendering Engine”, which can then be synced with FIG. 9A. “The sound Module” and can concurrently be projected onto FIG. 8A “Screen Types”, which can be seen in 3D in FIG. 6A through the audiences “Viewer Glasses” and the synced sound can be heard through the chosen audio system. The software system might utilize but will not be limited to 3D Rendering, Sync Software such as calibration software for taking in various capture sources such as a series of stereo cameras for example. The “Kernel” can host its Configuration Software on Dedicated Servers (Local or Wide Area), Content Delivery Networks (Local Area or over the internet), Distributed computing networks, Camera Modules that can handle for example, but not limited to camera output such as various views and calibration of those views, Device Controllers, Audio Controllers, Motion Capture Controllers, Projectors, Temperature Controllers, Smell Controllers, Hydraulic Controllers, Vibration Controllers and Time-Stamp Controllers used for calibration purposes to name a few.

FIG. 4 represents and example but should not be limited to environmental modules that comprise the overall physical experience, including the environment of the performance such as but not limited to lighting, vibration equipment, scent and smell equipment, temperature equipment, hydraulic equipment and wind/air machines.

FIG. 5 represents and example but should not be limited to capture devices that essentially capture various elements of the performance such as, but not limited to, cameras, 3D devices, lasers, radio transmitters, WiFi transmitters, GPS transmitters, Bluetooth, Infra-red, heat sensors, motion sensors, audio capture devices and more.

FIG. 6 represents and example but should not be limited to immersive visual devices that are designed to enhance and support the viewing experience of the users for example, glasses designed to view 3D, special effects or other visual events not viewable by the naked eye. The glasses could themselves have electronic capabilities to display events within the lens or to project images themselves.

FIG. 7 represents and example but should not be limited to broadcasting of the performance, live or offline via traditional airwaves, radio, satellite, or over internet. The performance could be downloaded offline, streamed live to devices or could be shared over social media channels.

FIG. 8 represents and example but should not be limited to any number of screen types which can be used to display for example, imagery or video. For example some projectors are designed to project onto standard, white theatrical screens, while others are specialized to project onto mist, to project onto the viewing devices themselves, for example the lens of the glasses worn by viewers, the eyes themselves or other dynamic media.

FIG. 9 represents and example but should not be limited to the audio module(s) that comprise the audible performance. For example traditional concert speaker setups can be used, in-ear/headphone systems, spacialization audio setups, 3D audio, audio/vibration devices designed to affect the skin, subconscious audio are also examples of audio devices that can be used in the system.

FIG. 10 represents and example but should not be limited to the Viewer tools that are utilized by the audience or viewers of the performance to aid in the driving of the performance, lesson or presentation. Control modules such as devices used to send commands to the “Kernel”. Devices used to take input from the watchers and viewers can be but will not be limited to gesture capture, direct input such as a control devices such as a remote controller, speech recognition or audio commands, physical motions, even commands using brain waves.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

1. A system for providing an multisensory performance to a viewer, comprising:
a plurality of capture modules configured to capture one or more sensory inputs for the multisensory performance;
at least one kernel module configured to organize the one or more sensory inputs to create the multisensory performance; and
a plurality of output modules configured to present the multisensory performance to the viewer.

2. A method for providing a multisensory performance to a viewer, comprising the steps of:
capturing one or more sensory inputs for a multisensory performance;
organizing the one or more sensory inputs into the multisensory performance; and
presenting the multisensory performance to the viewer.
